(19) United States
(12) Patent Application Publication
(10) Pub. No.: US 2020/0135114 A1
(43) Pub. Date: Apr. 30, 2020

(54) A PIXEL CIRCUIT, A DRIVING METHOD THEREOF, AND A DISPLAY APPARATUS

(71) Applicants: Chengdu BOE Optoelectronics Technology Co., Ltd., Chengdu, Sichuan (CN); BOE Technology Group Co., Ltd., Beijing (CN)

(72) Inventors: Sangwon Lee, Beijing (CN); Minho Ko, Beijing (CN); Sanghun Kang, Beijing (CN); Wen Tan, Beijing (CN); Youngyik Ko, Beijing (CN); Wanli Dong, Beijing (CN)

(73) Assignees: Chengdu BOE Optoelectronics Technology Co., Ltd., Chengdu, Sichuan (CN); BOE Technology Group Co., Ltd., Beijing (CN)

(21) Appl. No.: 16/616,964

(22) PCT Filed: Sep. 6, 2018
(86) PCT No.: PCT/CN2018/104352

§ 371 Date: Nov. 25, 2019

(30) Foreign Application Priority Data
Sep. 15, 2017 (CN) 201710834317.9

(51) Int. Cl. G09G 3/3258; G09G 3/3266; G09G 3/3291

(52) U.S. Cl. CPC G09G 3/3258; G09G 3/3266; G09G 2300/0861; G09G 2310/0262; G09G 2310/0251; G09G 3/3291

(57) ABSTRACT

The present application discloses a pixel circuit for a display panel. The circuit includes a first transistor coupled to a data line and configured to transfer a data signal in response to an N-th scan signal corresponding to an N-th row of pixels in the display panel. Additionally, the circuit includes a second transistor coupled to the first transistor and configured to generate a driving signal based on the data signal. The circuit further includes a third transistor coupled to the second transistor and configured to compensate a threshold voltage of the second transistor in response to an (N−1)-th scan signal corresponding to a previous (N−1)-th row of pixels in the display panel. Furthermore, the circuit includes a capacitor coupled between the second transistor and a first power voltage port for storing the data signal. Moreover, the circuit includes a light emitter driven by the driving signal to emit light.

### CROSS-REFERENCE TO RELATED APPLICATION

This application claims priority to Chinese Patent Application No. 201710834317.9, filed Sep. 15, 2017, the contents of which are incorporated by reference in the entirety.

### TECHNICAL FIELD

The present invention relates to display technology, more particularly, to a pixel circuit and a driving method thereof, and a display apparatus having the same.

### BACKGROUND

Display based on Organic Light Emitting Diode (OLED) has many advantages including wider view angles, higher brightness, higher contrast, lower power consumption, thinner in physical thickness over the current main stream display technology based on Thin-Film Transistor Liquid Crystal Display (TFT-LCD). The methods for driving the OLED display include passive matrix (PM) driving and active matrix (AM) driving. OLED display apparatus using the AM driving method, i.e., active-matrix OLED (AMOLED) display, is advantageous in displaying more information, consuming less energy, having longer life time and higher image contrast over PMOLED. FIG. 1 shows an equivalent circuit of an existing pixel-driving circuit for AMOLED display, including a first switch transistor M1, a driving transistor M2, a storage capacitor C1, and a light emitter D1.

Although the conventional pixel circuit shown in FIG. 1 has been widely used, some problems remain. For example, due to transistor fabrication process variation the threshold voltages Vth of the driving transistor M2 at different locations of the AMOLED display panel are non-uniform. The non-uniformity of Vth results in variations of data-driving signals Vdata and correspondingly variations of driving currents through different light-emitter D1. Therefore, the display image uniformity and light emission quality of the OLED display panel are affected.

### SUMMARY

In an aspect, the present disclosure provides a circuit for driving a light-emitting pixel in a display panel. The circuit includes a first transistor coupled to a data line and configured to transfer a data signal in response to an N-th scan signal corresponding to a current N-th row of multiple rows of pixels in the display panel. N is an integer greater than 2. The circuit further includes a second transistor coupled to the first transistor and configured to generate a driving signal based on the data signal. Additionally, the circuit includes a third transistor coupled to the second transistor and configured to compensate a threshold voltage of the second transistor in response to an (N−1)-th scan signal corresponding to a previous (N−1)-th row of the multiple rows of pixels in the display panel. Furthermore, the circuit includes a capacitor coupled between the second transistor and a first power voltage port for storing the data signal transferred from the first transistor. Moreover, the circuit includes a light emitter coupled to the second transistor to emit light controlled by the driving signal.

Optionally, the circuit further includes a fourth transistor coupled to a first electrode of the light emitter and an initializing voltage port and configured to discharge the data signal stored in the capacitor using an initializing voltage received at the initializing voltage port in response to the (N−1)-th scan signal.

Optionally, the fourth transistor includes a first electrode coupled to the initializing voltage port, a second electrode coupled to the first electrode of the light emitter, and a control electrode coupled to an (N−1)-th scan line receiving the (N−1)-th scan signal.

Optionally, the circuit further includes a fifth transistor coupled to the second transistor and configured to provide a first power voltage received at the first power voltage port to the second transistor in response to an N-th emission-control signal corresponding to the N-th row of the multiple rows of pixels in the display panel. Additionally, the circuit includes a sixth transistor coupled to the second transistor and configured to pass the driving signal to the light emitter in response to an (N+1)-th emission-control signal corresponding to a next (N+1)-th row of the multiple rows of pixels in the display panel.

Optionally, the fifth transistor includes a first electrode coupled to the first power voltage port, a second electrode coupled to a second electrode of the first transistor and a first electrode of the second transistor, and a control electrode coupled to an N-th emission-control line receiving the N-th emission-control signal.

Optionally, the sixth transistor includes a first electrode coupled to a second electrode of the second transistor and a second electrode of the third transistor, a second electrode coupled to the first electrode of the light emitter and the second electrode of the fourth transistor, and a control electrode coupled to an (N+1)-th emission-control line receiving the (N+1)-th emission-control signal.

Optionally, the first transistor includes a first electrode coupled to the data line receiving the data signal, a second electrode coupled to a first electrode of the second transistor, and a control electrode coupled to an N-th scan line receiving the N-th scan signal.

Optionally, the second transistor includes a first electrode coupled to the second electrode of the first transistor, a second electrode coupled to a second electrode of the third transistor, and a control electrode coupled to a second electrode of the capacitor and a first electrode of the third transistor.

Optionally, the third transistor includes a first electrode coupled to a control electrode of the second transistor, a second electrode coupled to a second electrode of the second transistor, and a control electrode coupled to an (N−1)-th scan line receiving the (N−1)-th scan signal.

Optionally, the capacitor includes a first electrode coupled to the first power voltage port and a second electrode coupled to a control electrode of the second transistor and a first electrode of the third transistor.

In another aspect, the present disclosure includes a pixel circuit for driving light emission of a pixel in an arbitrary N-th row of multiple rows of pixels in a display panel comprising a first transistor, a second transistor, a third transistor, a fourth transistor, a fifth transistor, a sixth transistor, a capacitor, and a light emitter. N is an integer greater than 2. A first electrode of the first transistor is coupled to a data line receiving a data signal. A second electrode of the first transistor is coupled to a first electrode of the second transistor. A control electrode of the first transistor is coupled to an N-th scan line associated with the display panel. A first electrode of the second transistor is coupled to the second electrode of the first transistor. A second electrode of the second transistor is coupled to a second electrode of the third transistor. A control electrode of the second transistor is coupled to a first electrode of the third transistor and a second electrode of the capacitor. A control electrode of the third transistor is coupled to an (N−1)-th scan line associated with the display panel. A first electrode of the fourth transistor is coupled to an initializing voltage port. A second electrode of the fourth transistor is coupled to a first electrode of the light emitter. A control electrode of the fourth transistor is coupled to the (N−1)-th scan line. A first electrode of the fifth transistor is coupled to a first power voltage port receiving a first power voltage. A second electrode of the fifth transistor is coupled to the second electrode of the first transistor and the first electrode of the second transistor. A control electrode of the fifth transistor is coupled to an N-th emission-control line associated with the display panel. A first electrode of the sixth transistor is coupled to the second electrode of the second transistor and the second electrode of the third transistor. A second electrode of the sixth transistor is coupled to the first electrode of the light emitter and the second electrode of the fourth transistor. A control electrode of the sixth transistor is coupled to an (N+1)-th emission-control line. A first electrode of the capacitor is coupled to the first power voltage port. A second electrode of the capacitor is coupled to the control electrode of the second transistor and the first electrode of the third transistor. A second electrode of the light emitter is coupled to a second power voltage port receiving a second power voltage. The second power voltage is lower than the first power voltage.

In yet another aspect, the present disclosure provides a method of driving light emission of a light-emitting pixel in a display panel. The method includes transferring a data signal from a data line via a first transistor to a current N-th row of multiple rows of pixels in the display panel in response to an N-th scan signal. N is an integer greater than 2. The method further includes generating a driving signal via a second transistor coupled to the first transistor based on the data signal. Additionally, the method includes coupling a third transistor to the second transistor to compensate a threshold voltage of the second transistor in response to an (N−1)-th scan signal corresponding to a previous (N−1)-th row of the multiple rows of pixels in the display panel. Furthermore, the method includes storing the data signal transferred from the first transistor in a capacitor coupled between the second transistor and a first power voltage port. Moreover, the method includes driving a light emitter coupled to the second transistor to emit light based on the driving signal.

In still another aspect, the present disclosure provides a method of driving the pixel circuit described herein in each scan cycle of displaying one frame of image. The method includes providing a transistor-turn-on voltage signal to the (N−1)-th scan line and the (N+1)-th emission-control line in a first period of a scan cycle. The method further includes setting the initializing voltage port at an initializing voltage. Additionally, the method includes making the second transistor, the third transistor, the fourth transistor, and the sixth transistor of the pixel circuit at an on-state to make each of a first common node of the control electrode of the second transistor and the first electrode of the third transistor, a second common node of the second electrode of the first transistor and the first electrode of the second transistor, a third common node of the second electrode of the second transistor and the first electrode of the sixth transistor, and a fourth common node of the second electrode of the fourth transistor and the second electrode of the sixth transistor to be at the initializing voltage. Moreover, the method includes discharging the data signal stored in the capacitor to the initializing voltage port.

Optionally, the method further includes providing a transistor-turn-on voltage signal to the (N−1)-th scan line and the N-th scan line in a second period of the scan cycle and sending a data signal to the data line. Additionally, the method includes making the first transistor, the second transistor, and the third transistor of the pixel circuit at an on-state to transfer the data signal from the first electrode of the first transistor to the first electrode of the second transistor. Furthermore, the method includes compensating a threshold voltage of the second transistor using the third transistor. Moreover, the method includes generating a driving signal based on the data signal by the second transistor to drive the light emitter to emit light.

Optionally, the method further includes providing a transistor-turn-on voltage signal to the N-th scan line in a third period after the second period of the scan cycle. Additionally, the method includes keeping the first transistor and the second transistor at an on-state to transfer the data signal from the first electrode of the first transistor to the first electrode of the second transistor. Furthermore, the method includes maintaining the threshold voltage of the second transistor being compensated the same as that in the second period. Moreover, the method includes writing the data signal from the data line to the first electrode of the second transistor to maintain the driving signal for driving the light emitter to emit light.

Optionally, the method further includes providing a transistor-turn-on voltage signal to the N-th emission-control line in a fourth period of the scan cycle and making the second transistor and the fifth transistor at an on-state to pass the first power voltage to both the first electrode and the second electrode of the second transistor.

Optionally, the method further includes providing a transistor-turn-on voltage signal to the N-th emission-control line and the (N+1)-th emission-control line in a fifth period of the scan cycle. Additionally, the method includes making the second transistor, the fifth transistor, and the sixth transistor at an on-state and driving the light emitter to emit light based on the driving signal that is substantially independent of the threshold voltage of the second transistor.

In yet still another aspect, the present disclosure provides a display apparatus having the circuit described herein.

### BRIEF DESCRIPTION OF THE FIGURES

The following drawings are merely examples for illustrative purposes according to various disclosed embodiments and are not intended to limit the scope of the present invention.

FIG. 1 is a schematic diagram of a conventional pixel circuit.

FIG. 2 is a schematic diagram of a pixel circuit according to an embodiment of the present disclosure.

FIG. 3 is a timing diagram of driving the pixel circuit of FIG. 2 according to an embodiment of the present disclosure.

FIG. 4 is a schematic diagram of the pixel circuit operated in period t1 in the timing diagram of FIG. 3 according to an embodiment of the present disclosure.

FIG. 5 is a schematic diagram of the pixel circuit operated in period t2 in the timing diagram of FIG. 3 according to an embodiment of the present disclosure.

FIG. 6 is a schematic diagram of the pixel circuit operated in period t3 in the timing diagram of FIG. 3 according to an embodiment of the present disclosure.

FIG. 7 is a schematic diagram of the pixel circuit operated in period t4 in the timing diagram of FIG. 3 according to an embodiment of the present disclosure.

FIG. 8 is a schematic diagram of the pixel circuit operated in period t5 in the timing diagram of FIG. 3 according to an embodiment of the present disclosure.

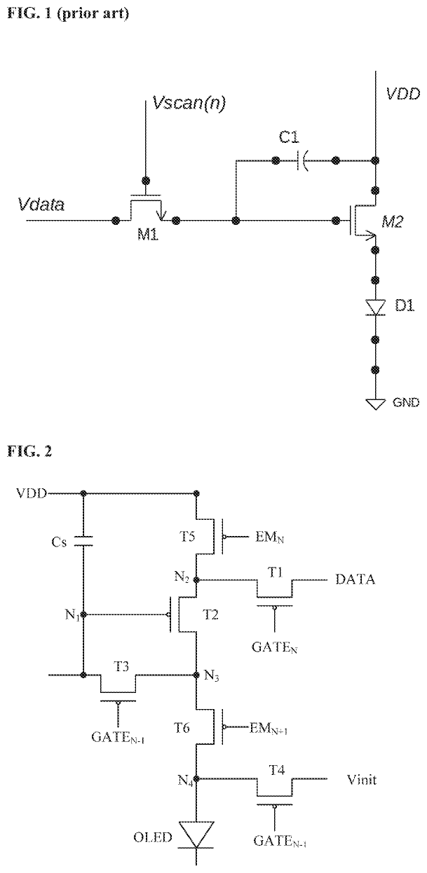

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

Accordingly, the present disclosure provides, inter alia, a pixel circuit and a method for driving light emission of pixels in a display panel, a display apparatus having the same that substantially obviate one or more of the problems due to limitations and disadvantages of the related art. In one aspect, the present disclosure provides a pixel circuit for driving pixels (or subpixels) of a light-emitting display panel to emit light for displaying image.

Optionally, the pixel circuit is based on thin-film transistors or field-effect transistors or some devices having similar functions and characteristics. Since the source electrode and the drain electrode of a thin-film transistor can be interchanged under certain application conditions, there is no difference in description of coupling of the source or drain electrode to other nodes in the circuit. In the description below, one of the source electrode and the drain electrode of a transistor is referred as a first electrode, and another one is referred as a second electrode, and the gate electrode of the transistor is referred as a control electrode. Optionally, a transistor can be characterized as an N-type or a P-type transistor depending on physical layer and doping configuration therein. For a P-type transistor, when the control electrode is applied with a turn-on voltage (which is at a low voltage level), the first electrode conducts to the second electrode of the P-type transistor at an on-state. P-type transistor is employed as an example for describing the embodiments of the present disclosure, although N-type transistor can also be used within the scope of the claims in this specification.

FIG. 2 shows a schematic diagram of a pixel circuit according to an embodiment of the present disclosure. Referring to FIG. 2, the pixel circuit includes at least a first transistor T1, a second transistor T2, a third transistor T3, a storage capacitor Cs, and a light emitter. Optionally, the light emitter is an organic light-emitting diode (OLED). Optionally, the pixel circuit also includes a fourth transistor T4, a fifth transistor T5, and a sixth transistor T6. Optionally, the pixel circuit is employed to drive light emission of a pixel (or a subpixel of one color) in a light-emitting display panel for image display. All pixels in the display panel are arranged in multiple rows. Optionally, for driving the pixel circuit, each row (e.g., an N-th row) of pixels is commonly associated with an (N-th) scan line for providing an (N-th) scan signal and alternatively associated with an (N-th) emission-control line for providing an (N-th) emission-control signal. N represents an arbitrary row of the pixels in the display panel. Optionally, the pixel circuit is supplied with a first power voltage from a first power voltage port VDD and the light emitter OLED is coupled to a second power voltage port receiving a second power voltage. Optionally, the second power voltage is lower than the first power voltage. Optionally, the second power voltage is a ground voltage.

Referring to FIG. 2, the first transistor T1 is coupled to a data line DATA receiving a data signal and configured to transfer the data signal in response to an N-th scan signal from a corresponding N-th scan line GATE_{N}. The second transistor T2 is coupled to the first transistor T1 and configured to generate a driving signal based on the data signal transferred by the first transistor T1 from the data line DATA. The third transistor T3 is coupled to the second transistor T2 and configured to compensate a threshold voltage of the second transistor T2 in response to an (N−1)-th scan signal from a corresponding (N−1)-th scan line GATE_{N-1} (adjacent to the N-th scan line). The storage capacitor Cs is configured with its first electrode coupled to the first power voltage port VDD and a second electrode coupled to the control electrode of the second transistor T2 and the first electrode of the third transistor T3. Cs is configured to store the data signal transferred to the second transistor T2. The light emitter OLED is configured to emit light driven by the driving signal generated by the second transistor T2.

The compensation to the threshold voltage of the second transistor T2 by the third transistor T3 is able to improve display uniformity of the display panel. The third transistor T3 is operated in response to the (N−1)-th scan signal, no control signal line is added to the pixel circuit for controlling the third transistor T3. This facilitates a high-resolution design for the display panel.

In an embodiment, the first transistor T1 is a P-type transistor with its gate electrode or control electrode being applied the N-th scan signal from the N-th scan line GATE_{N}. The data signal from the data line DATA applied to the source (first) electrode of the first transistor T is transferred to the drain (second) electrode of the first transistor T which is coupled to the source (first) electrode of the second transistor T2. The first electrode of the second transistor T2 is depicted as a node N₂ in FIG. 2.

In the embodiment, the second transistor T2 is a P-type transistor with its gate (control) electrode being coupled to the second electrode of the storage capacitor Cs, which is depicted as a node N₁ in FIG. 2. The drain (second) electrode of the second transistor T12 is coupled to the drain (second) electrode of the third transistor T3, which is depicted as a node N₃ in FIG. 2 and is also the first electrode of the light emitter OLED. The second electrode of the light emitter OLED is coupled to the second power voltage port.

In the embodiment, the third transistor T3 is a P-type transistor with its source (first) electrode and drain (second) electrode respectively being coupled to the gate (control) electrode and drain (second) electrode of the second transistor T2. The gate (control) electrode of the third transistor T3 is coupled to the (N−1)-th scan line GATE_{N-1}.

The storage capacitor has its first electrode coupled to the first power voltage port VDD configured to receive a first power voltage.

Additionally in the embodiment, the pixel circuit includes a fourth transistor T4. The fourth transistor T4 has a source (first) electrode coupled to an initializing voltage port Vinit. The fourth transistor T4 has a drain (second) electrode coupled to the first electrode of the light emitter OLED, which is also depicted as a node N₄ in FIG. 2. The fourth transistor T4 has its gate (control) electrode coupled to the (N−1)-th scan line GATE_{N-1}. The fourth transistor T4, optionally a P-type transistor, is configured to use an initializing voltage received from the initializing voltage port Vinit to initialize voltage levels at the nodes N₁, N₂, N₃, and N₄ and to discharge the data signal stored in the storage capacitor Cs into the initializing voltage port.

Referring to FIG. 2 again, the pixel circuit further includes a fifth transistor T5 and a sixth transistor T6. The fifth transistor T5 is coupled to the node N₂ and configured to provide the first power voltage to the second transistor T2 in response to an N-th emission-control signal from an N-th emission-control line EM_{N}. The sixth transistor T6 is coupled between the node N₃ and the node N₄ and configured to output the driving signal generated by the second transistor T2 to the light emitter OLED in response to an (N+1)-th emission-control signal from an (N+1)-th emission-control line EM_{N+1} (adjacent to the N-th emission control line).

In the embodiment, the fifth transistor T5 is a P-type transistor with its source (first) electrode being coupled to the first power voltage port VDD. The drain (second) electrode of the fifth transistor T5 is coupled to the source (first) electrode of the second transistor T2. The gate (control) electrode of the fifth transistor T5 is coupled to the N-th emission-control line EM_{N}.

In the embodiment, the sixth transistor T6 is also a P-type transistor with its source (first) electrode being coupled to the drain (second) electrode of the second transistor T2 and the drain (second) electrode of the third transistor T3. The second electrode of the sixth transistor T6 is coupled to the first electrode of the light emitter OLED and the drain (second) electrode of the fourth transistor T4. The gate (control) electrode of the sixth transistor T6 is coupled to the (N+1)-th emission-control line EM_{N+1}.

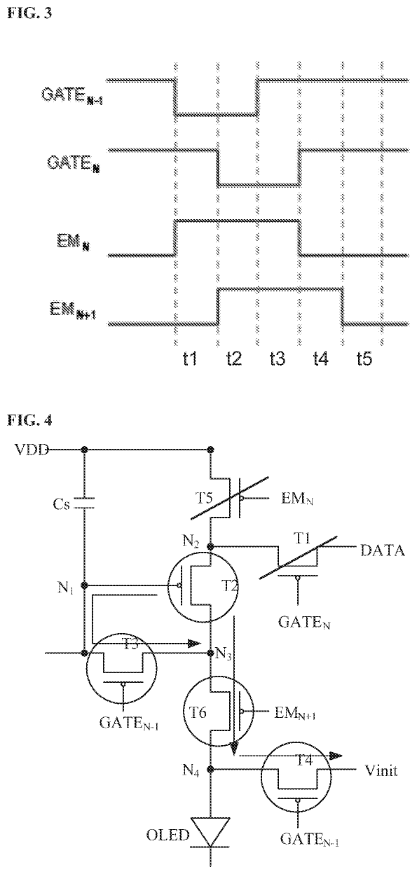

In another aspect, the present disclosure provides a method of driving the pixel circuit of FIG. 2 in a light-emitting display panel. FIG. 3 shows a timing diagram of driving the pixel circuit of FIG. 2 according to an embodiment of the present disclosure. Referring to both FIG. 2 and FIG. 3, the method of driving the pixel circuit includes operating the pixel circuit in a N-th row of the display panel by an N-th scan signal applied to the N-th scan line and an (N−1)-th scan signal applied to the (N−1)-th scan line as well as by an N-th emission-control signal applied to the N-th emission-control line and an (N+1)-th emission-control signal applied to the (N+1)-th emission-control line.

Referring to FIG. 2, the pixel circuit includes a first transistor T1, a second transistor T2, a third transistor T3, a fourth transistor T4, a fifth transistor T5, a sixth transistor T6, a storage capacitor Cs, and a light emitting device OLED. The first electrode of the first transistor T1 is coupled to a data line DATA. The second electrode of the first transistor T1 is coupled to a first electrode of the second transistor T2. The control electrode of the first transistor T1 is coupled to the N-th scan line GATE_{N}. The first electrode of the second transistor T2 is coupled to the second electrode of the first transistor T1. The second electrode of the second transistor T2 is coupled indirectly to a first electrode of the light emitting device OLED. The control electrode of T2 is coupled to a first electrode of the third transistor T3 and a second electrode of the storage capacitor Cs, which is the node N₁. The first electrode of the third transistor T3 is coupled to the control electrode of T2 and the second electrode of Cs. The second electrode of T3 is indirectly coupled to the first electrode of OLED. The control electrode of T3 is coupled to the (N−1)-th scan line GATE_{N-1}.

The fifth transistor T5 includes a first electrode coupled to a first power voltage port VDD, a second electrode coupled to the second electrode of T1 and the first electrode of T2, which is the node N₂, and a control electrode coupled to the N-th emission-control line EM_{N}. The sixth transistor T6 includes a first electrode coupled to the second electrode of T2 and the second electrode of T3, which is also the node N₃. T6 also includes a second electrode coupled directly to the first electrode of the light emitting device OLED and a second electrode of the fourth transistor T4, which is also the node N₄. T6 further includes a control electrode coupled to the (N+1)-th emission-control line EM_{N+1}.

The storage capacitor Cs includes a first electrode coupled to the first power voltage port VDD and a second electrode coupled to the node N₁. The light emitting device OLED includes a first electrode coupled to the node N4 and a second electrode coupled to the second power voltage port which is supplied with a low voltage compared to the first power voltage port VDD.

In some embodiment, the method of driving the pixel circuit described above (FIG. 2) includes operating the pixel circuit in one of five periods of each scan cycle of displaying one frame of image on the display panel. In particular, the scan cycle includes a first period t1 for initializing voltage levels at several nodes of the pixel circuit. Also, the scan cycle includes a second period t2 for inputting data and compensating threshold voltage of the (driving) second transistor T2. Further, the scan cycle includes a third period t3 for inputting data and maintaining threshold voltage compensation. The third period is at least after the second period. Furthermore, the scan cycle includes a fourth period t4 for writing in the first power voltage from the first power voltage port. Moreover, the second cycle includes a fifth period t5 for driving the light emitting device to emit light with a driving signal being controlled to be independent of the threshold voltage of the second transistor T2.

Referring to FIG. 3, in the first period t1 of a scan cycle, the method of driving the pixel circuit is also shown in FIG. 4 according to an embodiment of the present disclosure. The method includes providing a transistor-turn-on voltage signal to the (N−1)-th scan line GATE_{N-1} and the (N+1)-th emission-control line EM_{N+1} in the period t1. Optionally, the transistor-turn-on voltage signal is a low voltage signal configured to turn on a P-type transistor. Additionally the method includes setting the initializing voltage port at an initializing voltage. Furthermore, the method includes making the second transistor T2, the third transistor T3, the fourth transistor T4, and the sixth transistor T6 at an on-state. This allows each of a first common node N₁ of the control electrode of the second transistor and the first electrode of the third transistor, a second common node N₂ of the second electrode of the first transistor and the first electrode of the second transistor, a third common node N₃ of the second electrode of the second transistor and the first electrode of the sixth transistor, and a fourth common node N₄ of the second electrode of the fourth transistor and the second electrode of the sixth transistor to be at the initializing voltage to be discharged to the initializing voltage. This in turn initializes the data signal stored in the storage capacitor Cs to the initializing voltage or discharges the charges in the Cs to the initializing voltage port.

Referring to FIG. 3 again, in the second period t2 of the scan cycle, the method of driving the pixel circuit is also shown in FIG. 5 according to an embodiment of the present disclosure. The method includes providing a transistor-turn-on voltage signal to the (N−1)-th scan line GATE_{N-1} and the N-th scan line GATE_{N} in the second period t2. The method further includes sending a data signal Vdata to the data line DATA. In this period, the method includes making the first transistor T1, the second transistor T2, and the third transistor T3 at an on-state to transfer the data signal Vdata from the first electrode of the first transistor T1 to the first electrode of the second transistor T2. The data signal Vdata is written into the node N₂. Since the second transistor T2 and the third transistor T3 are turned on at the same time, the voltage levels of the node N₁ and node N₂ are all equal to Vdata+Vth. Here, Vth is the threshold voltage of the second transistor T2. The method then includes compensating the threshold voltage Vth of the second transistor T2 using the third transistor T3, as indicated in FIG. 5. The method further includes generating a driving signal based on the data signal Vdata (with Vth compensation by the third transistor T3) by the second transistor T2 to drive the light emitting device OLED to emit light.

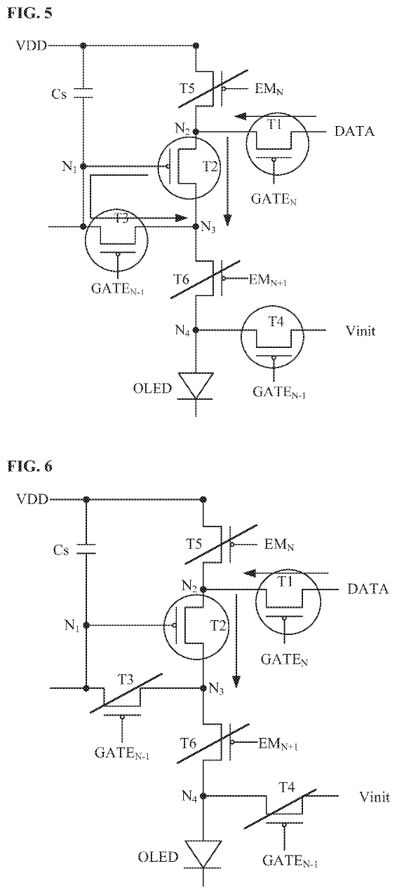

Referring to FIG. 3, in the third period t3 of the scan cycle, the method of driving the pixel circuit is also shown in FIG. 6 according to an embodiment of the present disclosure. The method includes providing a transistor-turn-on voltage signal to the N-th scan line GATE_{N} in the third period t3 after the second period t2 of the scan cycle. The method then includes keeping the first transistor T1 and the second transistor T2 at an on-state to transfer the data signal Vdata from the first electrode of the first transistor T1 to the first electrode of the second transistor T2 or to the node N₂. Additionally, the method includes maintaining the threshold voltage of the second transistor being compensated the same as that in the second period. Therefore, the voltage level at the node N₃ is maintained to be Vdata+Vth. At the time, the method includes further writing the data signal from the data line to the node N₂ to maintain the storage capacitor Cs fully charged with the Vdata and the second transistor T2 to keep the driving signal for driving the light emitter OLED to continue emitting light. At the same time, since the voltage level at the node N₃ is maintained, the drift of the threshold voltage Vth of the second transistor T2 is substantially prevented to not affecting the image display.

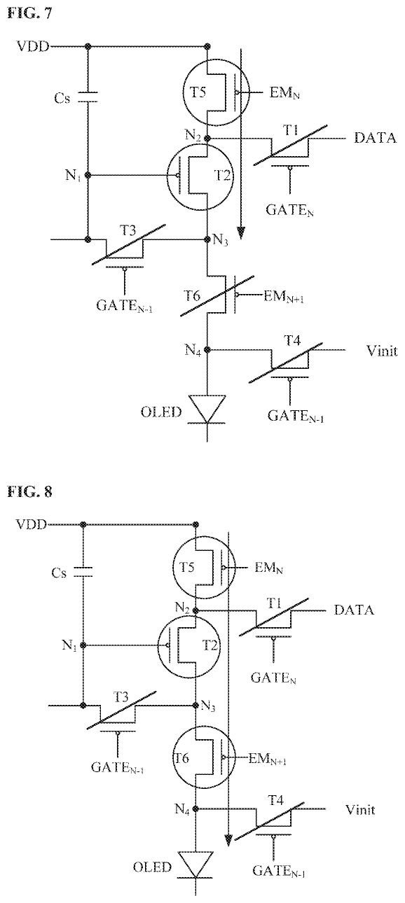

Referring to FIG. 3, in the fourth period t4 of the scan cycle, the method of driving the pixel circuit is also shown in FIG. 7 according to an embodiment of the present disclosure. The method includes providing a transistor-turn-on voltage signal to the N-th emission-control line EM_{N} in the fourth period t4 of the scan cycle. The method then includes making the second transistor T2 and the fifth transistor T5 at an on-state to pass the first power voltage VDD to the node N₂ (i.e., the first electrode of the second transistor T2) and the node N₃ (i.e., the second electrode of the second transistor T2). This effectively prevents current leakage of the second transistor T2 in this period.

Referring to FIG. 3, in the fifth period t5 of the scan cycle, the method of driving the pixel circuit is also shown in FIG. 8 according to an embodiment of the present disclosure. The method includes providing a transistor-turn-on voltage signal to the N-th emission-control line EM_{N} and the (N+1)-th emission-control line EM_{N+1} in the fifth period t5 of the scan cycle. The method then includes making the second transistor T2, the fifth transistor T5, and the sixth transistor T6 at an on-state. Further, the method includes driving the light emitter OLED to emit light. At this period, the driving signal Ids is equal to k×(Vdata-VDD)², which is substantially independent of the threshold voltage Vth of the second transistor T2. Thus, the effect of drifting threshold voltage Vth of the driving transistor (T2) on the light emitter OLED is substantially avoided.

In yet another aspect, the present disclosure also provides a display apparatus including the pixel circuit described herein. Among all applications of the display apparatus, it includes, but not limited to, OLED display panel, smart phone, tablet computer, TV, displayer, notebook computer, digital picture frame, navigator, and any products or components having display function.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A circuit for driving a light-emitting pixel in a display panel comprising:
a first transistor coupled to a data line and configured to transfer a data signal in response to an N-th scan signal corresponding to a current N-th row of multiple rows of pixels in the display panel, wherein N is an integer greater than 2;
a second transistor coupled to the first transistor and configured to generate a driving signal based on the data signal;
a third transistor coupled to the second transistor and configured to compensate a threshold voltage of the second transistor in response to an (N−1)-th scan signal corresponding to a previous (N−1)-th row of the multiple rows of pixels in the display panel;
a capacitor coupled between the second transistor and a first power voltage port for storing the data signal transferred from the first transistor; and
a light emitter coupled to the second transistor to emit light controlled by the driving signal.

2. The circuit of claim 1, further comprising a fourth transistor coupled to a first electrode of the light emitter and an initializing voltage port and configured to discharge the data signal stored in the capacitor using an initializing voltage received at the initializing voltage port in response to the (N−1)-th scan signal.

3. The circuit of claim 2, wherein the fourth transistor comprises a first electrode coupled to the initializing voltage port, a second electrode coupled to the first electrode of the light emitter, and a control electrode coupled to an (N−1)-th scan line receiving the (N−1)-th scan signal.

4. The circuit of claim 3, further comprising:
a fifth transistor coupled to the second transistor and configured to provide a first power voltage received at the first power voltage port to the second transistor in response to an N-th emission-control signal corresponding to the N-th row of the multiple rows of pixels in the display panel;
a sixth transistor coupled to the second transistor and configured to pass the driving signal to the light emitter in response to an (N+1)-th emission-control signal corresponding to a next (N+1)-th row of the multiple rows of pixels in the display panel.

5. The circuit of claim 4, wherein the fifth transistor comprises a first electrode coupled to the first power voltage port, a second electrode coupled to a second electrode of the first transistor and a first electrode of the second transistor, and a control electrode coupled to an N-th emission-control line receiving the N-th emission-control signal.

6. The circuit of claim 4, wherein the sixth transistor comprises a first electrode coupled to a second electrode of the second transistor and a second electrode of the third transistor, a second electrode coupled to the first electrode of the light emitter and the second electrode of the fourth transistor, and a control electrode coupled to an (N+1)-th emission-control line receiving the (N+1)-th emission-control signal.

7. The circuit of claim 1, wherein the first transistor comprises a first electrode coupled to the data line receiving the data signal, a second electrode coupled to a first electrode of the second transistor, and a control electrode coupled to an N-th scan line receiving the N-th scan signal.

8. The circuit of claim 1, wherein the second transistor comprises a first electrode coupled to the second electrode of the first transistor, a second electrode coupled to a second electrode of the third transistor, and a control electrode coupled to a second electrode of the capacitor and a first electrode of the third transistor.

9. The circuit of claim 1, wherein the third transistor comprises a first electrode coupled to a control electrode of the second transistor, a second electrode coupled to a second electrode of the second transistor, and a control electrode coupled to an (N−1)-th scan line receiving the (N−1)-th scan signal.

10. The circuit of claim 1, wherein the capacitor comprises a first electrode coupled to the first power voltage port and a second electrode coupled to a control electrode of the second transistor and a first electrode of the third transistor.

11. A pixel circuit for driving light emission of a pixel in an arbitrary N-th row of multiple rows of pixels in a display panel comprising a first transistor, a second transistor, a third transistor, a fourth transistor, a fifth transistor, a sixth transistor, a capacitor, and a light emitter, wherein N is an integer greater than 2:
a first electrode of the first transistor is coupled to a data line receiving a data signal, a second electrode of the first transistor is coupled to a first electrode of the second transistor, and a control electrode of the first transistor is coupled to an N-th scan line associated with the display panel;
a first electrode of the second transistor is coupled to the second electrode of the first transistor, a second electrode of the second transistor is coupled to a second electrode of the third transistor, and a control electrode of the second transistor is coupled to a first electrode of the third transistor and a second electrode of the capacitor;
a control electrode of the third transistor is coupled to an (N−1)-th scan line associated with the display panel;
a first electrode of the fourth transistor is coupled to an initializing voltage port, a second electrode of the fourth transistor is coupled to a first electrode of the light emitter, and a control electrode of the fourth transistor is coupled to the (N−1)-th scan line;
a first electrode of the fifth transistor is coupled to a first power voltage port receiving a first power voltage, a second electrode of the fifth transistor is coupled to the second electrode of the first transistor and the first electrode of the second transistor, and a control electrode of the fifth transistor is coupled to an N-th emission-control line associated with the display panel;
a first electrode of the sixth transistor is coupled to the second electrode of the second transistor and the second electrode of the third transistor, a second electrode of the sixth transistor is coupled to the first electrode of the light emitter and the second electrode of the fourth transistor, and a control electrode of the sixth transistor is coupled to an (N+1)-th emission-control line;
a first electrode of the capacitor is coupled to the first power voltage port and a second electrode of the capacitor is coupled to the control electrode of the second transistor and the first electrode of the third transistor; and
a second electrode of the light emitter is coupled to a second power voltage port receiving a second power voltage, the second power voltage being lower than the first power voltage.

12. A method of driving light emission of a light-emitting pixel in a display panel comprising:
transferring a data signal from a data line via a first transistor to a current N-th row of multiple rows of pixels in the display panel in response to an N-th scan signal, wherein N is an integer greater than 2;
generating a driving signal via a second transistor coupled to the first transistor based on the data signal;
coupling a third transistor to the second transistor to compensate a threshold voltage of the second transistor in response to an (N−1)-th scan signal corresponding to a previous (N−1)-th row of the multiple rows of pixels in the display panel;
storing the data signal transferred from the first transistor in a capacitor coupled between the second transistor and a first power voltage port; and
driving a light emitter coupled to the second transistor to emit light based on the driving signal.

13. A method of driving the pixel circuit of claim 11 in each scan cycle of displaying one frame of image comprising:
providing a transistor-turn-on voltage signal to the (N−1)-th scan line and the (N+1)-th emission-control line in a first period of a scan cycle;
setting the initializing voltage port at an initializing voltage;
making the second transistor, the third transistor, the fourth transistor, and the sixth transistor at an on-state to make each of a first common node of the control electrode of the second transistor and the first electrode of the third transistor, a second common node of the second electrode of the first transistor and the first electrode of the second transistor, a third common node of the second electrode of the second transistor and the first electrode of the sixth transistor, and a fourth common node of the second electrode of the fourth transistor and the second electrode of the sixth transistor to be at the initializing voltage; and
discharging the data signal stored in the capacitor to the initializing voltage port.

14. The method of claim 13, further comprising:
providing a transistor-turn-on voltage signal to the (N−1)-th scan line and the N-th scan line in a second period of the scan cycle;
sending a data signal to the data line;
making the first transistor, the second transistor, and the third transistor at an on-state to transfer the data signal from the first electrode of the first transistor to the first electrode of the second transistor;
compensating a threshold voltage of the second transistor using the third transistor; and
generating a driving signal based on the data signal by the second transistor to drive the light emitter to emit light.

15. The method of claim 14, further comprising:
providing a transistor-turn-on voltage signal to the N-th scan line in a third period after the second period of the scan cycle;
keeping the first transistor and the second transistor at an on-state to transfer the data signal from the first electrode of the first transistor to the first electrode of the second transistor;
maintaining the threshold voltage of the second transistor being compensated the same as that in the second period; and
writing the data signal from the data line to the first electrode of the second transistor to maintain the driving signal for driving the light emitter to emit light.

16. The method of claim 15, further comprising:
providing a transistor-turn-on voltage signal to the N-th emission-control line in a fourth period of the scan cycle; and
making the second transistor and the fifth transistor at an on-state to pass the first power voltage to both the first electrode and the second electrode of the second transistor.

17. The method of claim 16, further comprising:
providing a transistor-turn-on voltage signal to the N-th emission-control line and the (N+1)-th emission-control line in a fifth period of the scan cycle;
making the second transistor, the fifth transistor, and the sixth transistor at an on-state; and
driving the light emitter to emit light based on the driving signal that is substantially independent of the threshold voltage of the second transistor.

18. A display apparatus comprising a circuit of claim 1.
